(19) United States
(12) Patent Application Publication
(10) Pub. No.: US 2005/0037175 A1
(43) Pub. Date: Feb. 17, 2005

(54) Open mesh in tufted wall or floor covering

(75) Inventors: Robert E. Loyd, Daleville, VA (US); J. Scott Jordan, Murrell's Inlet, SC (US)

Correspondence Address: NIXON & VANDERHYE, PC, 1100 N GLEBE ROAD, 8TH FLOOR, ARLINGTON, VA, 22201-4714, US

(73) Assignee: BURLINGTON INDUSTRIES, INC., Greensboro, NC (US)

(21) Appl. No.: 10/641,015

(22) Filed: Aug. 15, 2003

(51) Int. Cl. B32B 3/02

(52) U.S. Cl. 428/95; 428/96; 427/402

(57) ABSTRACT

The covering includes, in order from exposed surface to underside, a tufted primary, a VAE precoat, a first layer of PVC, a fiberglass woven material, preferably a leno weave fiberglass material, embedded in the first layer of PVC and a final layer of PVC forming the underside of the covering. Dimensional stability is achieved with the woven or the leno weave fiberglass material utilizing minimal quantities of PVC, while providing adequate curl and drape properties to the covering.

### BACKGROUND OF THE INVENTION

The present invention relates to a wall or floor covering having an open mesh forming part of the secondary backing and relates to a wall or floor covering having a tufted primary backing with a woven fiberglass material forming part of a secondary backing. More particularly, this invention relates to the use of a woven fiberglass such as plain, satin, twill and basket weaves, and preferably a leno weave, as the secondary backing.

In current wall or floor coverings, a primary backing is tufted and a VAE precoat material is applied to the back side of the primary backing to facilitate retention of the tufted yarns in the primary backing. A first backcoating of PVC is typically applied and an overlay of a non-woven fiberglass secondary backing material is applied over the first PVC backcoating. A second PVC backcoating is then applied to overlay the non-woven fiberglass material to create a smooth PVC layer on the back side of the secondary backing. While secondary backings of this type have afforded substantial dimensional stability and satisfactory resistance to drape and curl, substantial quantities of PVC material are utilized in the formation of such secondary backings. It has therefore been found desirable to provide a different form of secondary backing in which reduced quantities of PVC material are required for the back coating(s).

### BRIEF DESCRIPTION OF THE INVENTION

A tufted primary backing is provided with a precoat of VAE as in the current covering. It will be appreciated, however, that other suitable precoat materials may be used in place of VAE (vinyl acetate-ethylene) such as SBR (styrene butadiene) latex, acrylics, and even a PVC (polyvinyl chloride) precoat. Suitable latex, resinous or adhesive materials may be provided to overlie the VAE precoating. However, a PVC backcoating is preferred to overlie the VAE precoat. Instead of a non-woven fiberglass mat as used in the above-identified prior secondary backing coverings, a preferred embodiment of the present invention provides an open mesh material, preferably a woven fiberglass material as part of the secondary backing. Woven fiberglass, such as plain, satin, twill or basket weaves may be used. More preferably, a leno weave fiberglass material is used as part of the secondary backing material. When a woven fiberglass and the preferred leno weave fiberglass material are applied, e.g., to the initial PVC backcoating, it is embedded into the initial PVC backcoating by using a roller. A second layer of PVC is then applied over the embedded woven or leno weave fiberglass material and the product is passed through an oven where the PVC is cured. The PVC may be a PVC plastisol. While a woven fiberglass mat, i.e., an open mesh material, is preferred, other types of yarns may be provided forming the woven mat. For example, polyester, polyolefins, polypropylene, nylon 6, nylon 66, and PLA yarns as well as PVC-coated yarns, acrylic-coated yarns, polyurethane-coated yarns and others may be used.

In a preferred embodiment according to the present invention, there is provided a covering for a wall or floor comprising a primary backing, a yarn tufted into the primary backing and forming an exposed surface, a precoat layer of one of VAE, a latex, an acrylic and a PVC precoat along a side of the primary backing opposite from the exposed surface, a first layer of one of a latex, resinous or adhesive material overlying the precoat layer, a second layer of one of a latex resinous or adhesive material overlying the first layer and a woven fiberglass material in contact with one of the precoat layer, the first layer and the second layer.

In a further preferred embodiment according to the present invention, there is provided a method of forming a wall or floor covering comprising the steps of (a) tufting yarn through a primary backing to form a surface with exposed tufts and an undersurface of the primary backing opposite the exposed surface, (b) applying a precoat of VAE to the undersurface, (c) applying a first layer of one of a latex, resinous or adhesive material to the VAE precoat, (d) applying a second layer of one of a latex, resinous, or adhesive material to the woven material and (e) applying a woven fiberglass in contact with one of the VAE precoat, the first layer and the second layer.

### BRIEF DESCRIPTION OF THE DRAWINGS

FIG. 1 is a fragmentary schematic cross-sectional view illustrating various layers forming a covering according to a preferred embodiment of the present invention;

FIGS. 2a-2g are sequential illustrations of a method of forming the covering hereof; and

FIG. 3 is an enlarged fragmentary plan view of a leno weave fiberglass material used in the covering of FIG. 1.

### DETAILED DESCRIPTION OF THE INVENTION

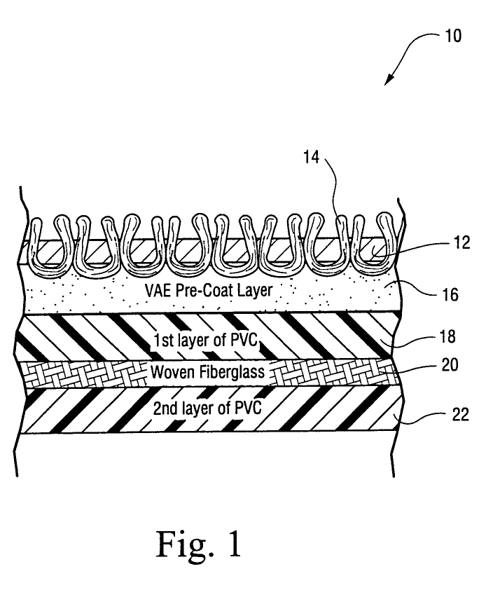

Referring now to the drawing figures, particularly to FIG. 1, there is illustrated a covering, generally designated 10. The covering 10 of the present invention may be utilized as part of a wall covering or as carpeting and preferably is provided in the form of carpet tiles. As illustrated, the covering includes a primary backing 12 in which yarns 14 are tufted. While cut loop yarns are illustrated, it will be appreciated that the covering may comprise tufted loop or cut loop products. The primary backing 12 may comprise any of the typical primary backing materials through which yarns 14 may be tufted, such as woven polypropylene or spun bonded fabrics. The back side of the tufted primary backing 12 is provided with a preferred VAE precoat layer 16 which serves to maintain the tufts in the primary backing 12. Other precoat layers may include SBR, PVC, or an acrylic. On the back side of the preferred VAE precoat layer 16, there is provided a first layer 18 of a latex, resinous or adhesive material, preferably PVC.

A further layer 20 of open mesh material, preferably woven fiberglass, is provided in the first, preferably PVC, layer. The woven fiberglass material 20 may be provided in plain, satin, twill or basket weaves and is preferably provided in a fiberglass leno weave construction. As a final backing, a second layer of preferably the same latex, resinous or adhesive material, preferably PVC, is applied as a final layer 22. It will be appreciated that the VAE and PVC layers are cured with the final PVC layer 22 forming the undersurface of the covering 10. With the woven fiberglass construction, and especially with the leno weave fiberglass construction, characteristics such as dimensional stability as noted in detail below, and resistance to drape and curl are provided to the covering with significantly less PVC material than previously provided in currently formed coverings utilizing fiberglass non-woven mat material in the secondary backing.

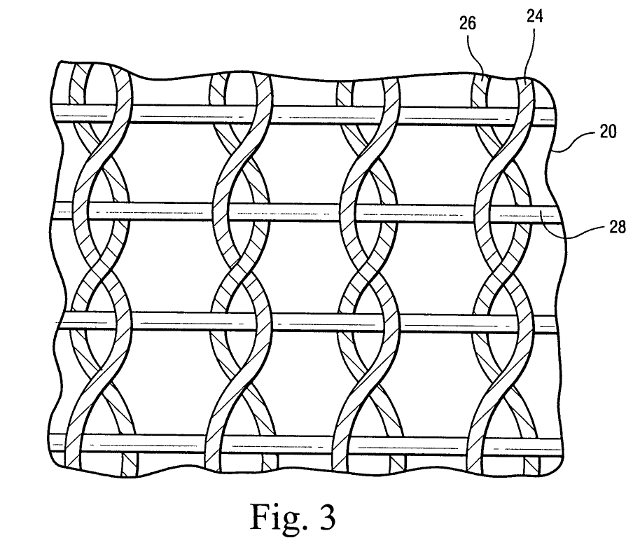

Referring to FIG. 3, the leno weave fiberglass construction is illustrated. The construction includes warp yarns 24 and 26 which are passed from side to side and rotated or twisted with weft or filling yarns 28 extending between the half turn twisted warp yarns. The warp yarns are bound in by the filling yarns as illustrated. This type of weave has substantial strength and stability due to the figure-eight half turn twists of the warp yarns which also prevent the filling yarns from slipping. By forming the secondary backing with leno weave fiberglass warp and weft yarns, the dimensional stability and other beneficial characteristics of the covering are achieved with substantial reduction in the quantity of PVC material used in the secondary backing.

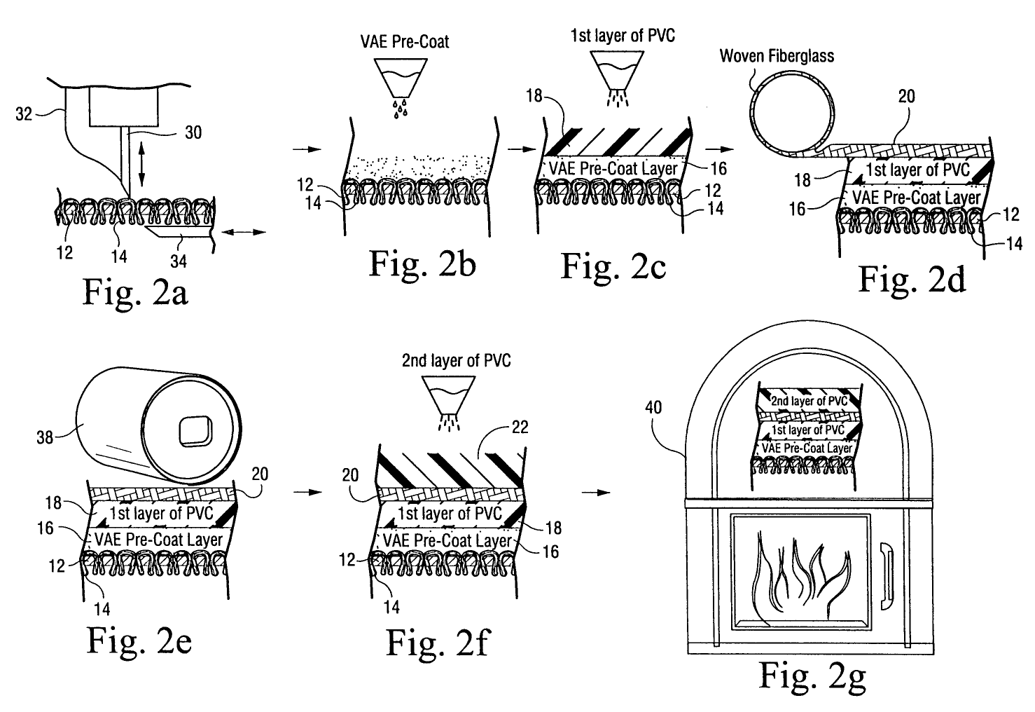

Referring now to FIG. 2, there is schematically illustrated a preferred process for constructing the floor or wall covering 10. In the initial drawing FIG. 2a, the primary backing 12 is tufted by punching through the backing 12 with a needle 40 carrying the tufting yarn 32 to form the tufts 14. If desired, a shearing mechanism is schematically illustrated at 34 for shearing the loops on the exposed, e.g., wear surface of the covering. In FIG. 2b, the VAE precoat is applied to the back side of the primary backing 12 to fix the tufted yarns 14 in the primary backing 12. While not shown, the preferred VAE precoat is cured prior to the addition of any further coating layers to the covering as illustrated in subsequent figures. In FIG. 2c and after the VAE precoat layer is cured, the first layer 18 of the latex, resinous or adhesive material, preferably PVC, is applied to the back side of the VAE precoat layer. Next, as illustrated in FIG. 2d, an open mesh material, e.g., a woven fiberglass material, and preferably the leno weave fiberglass material 20 is applied on top of the first layer 18 of PVC. A roll 38 is then applied (FIG. 2e) to the woven fiberglass or the leno weave material 20 embed the fiberglass material 20 in the first layer 18 of PVC. Next, as illustrated in FIG. 2f, a second layer 22 of PVC is applied over the embedded fiberglass material 20. The second layer 22 is preferably PVC, although the second layer 22 may comprise a latex, resinous or adhesive material, e.g., a PVC, preferably the same latex, resinous or adhesive material as comprising the first layer 18. Finally, the covering 10 is passed through an oven where the PVC material is cured.

By utilizing an open mesh material, e.g., a woven fiberglass construction, and especially when using the leno weave fiberglass construction, dimensional stability for the floor or wall covering is achieved with substantially less than the standard quantity of PVC utilized in backcoating constructions having fiberglass non-woven mat material as part of the secondary backing. Also, this construction has adequate resistance to curl and drape.

Dimensional stability tests were performed on the floor or wall covering using the leno weave fiberglass construction as well as on the conventional covering previously discussed using the non-woven fiberglass construction. Comparative results are shown below:

| Covering Using Leno Weave | | | Covering Using Non-Woven | | |
|---|---|---|---|---|---|
| Fiberglass Construction | | | Fiberglass Construction | | |
| Test | Measure- | Percent | Test | Measure- | Percent |
| Condition | ment | Change | Condition | ment | Change |
| M₀ | 18.0113″ | | M₀ | 18.0088″ | |
| MT₁ | 18.0100″ | −0.007 | MT₁ | 18.0038″ | −0.028 |
| MT₂ | 18.0163″ | +0.028 | MT₂ | 17.9975″ | −0.062 |
| MT₃ | 18.0063″ | −0.028 | MT₃ | 17.9938″ | −0.083 |
| MT₄ | 18.0100″ | −0.007 | MT₄ | 17.9988″ | −0.056 |
| | | −0.0013″ | | | −0.0100 |
| C₀ | 18.0350″ | | C₀ | 18.0188″ | |
| CT₁ | 18.0175″ | −0.097 | CT₁ | 18.0100″ | −0.049 |
| CT₂ | 18.0725″ | +0.208 | CT₂ | 18.0113″ | −0.042 |
| CT₃ | 17.9950″ | −0.222 | CT₃ | 18.0013″ | −0.097 |
| CT₄ | 18.0263″ | −0.049 | CT₄ | 18.0125″ | −0.035 |
| | | −0.0087″ | | | −0.0062″ |

Test Condition Key:
M₀ Machine Direction Original Measurement
C₀ Cross Direction Original Measurement
T₁ Two (2) hours in an oven at 60° C.
T₂ Two (2) hours in a .1% solution at 20° C.
T₃ Twenty-four (24) hours in an oven at 60° C.
T₄ Forty-eight (48) hours in standard climate at 21° C. & 65% RH

As evident from the foregoing Tables, dimensional stability was substantially improved in the machine direction in the covering having the leno weave construction as compared with the covering using the conventional non-woven fiberglass construction and without substantial reduction in the cross-machine direction. This was accomplished in the final product hereof using substantially less quantities of PVC and hence represented a significant cost saving, while at least maintaining comparable or improved dimensional stability.

The woven fiberglass is preferably placed between the two PVC layers 18 and 22. However, it will be appreciated that the open mesh material, e.g., the woven fiberglass, may be applied to the primary backing prior to application of the precoat, after the precoat has been applied and followed by one or two coatings of the materials identified above, e.g., PVC, or after application of the precoat and a first layer, e.g., PVC as in the described preferred embodiment or after application of layers subsequent to the precoat, e.g., after the two PVC layers 18 and 22.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A covering for a wall or floor comprising:
a primary backing;
a yarn tufted into the primary backing and forming an exposed surface;
a precoat layer of one of VAE, a latex, an acrylic and a PVC precoat along a side of the primary backing opposite from the exposed surface;
a first layer of one of a latex, resinous, PVC or adhesive material overlying the precoat layer;
a second layer of one of a latex resinous PVC or adhesive material overlying the first layer; and
a woven fiberglass material in contact with one of said precoat layer, said first layer and said second layer.

2. A covering according to claim 1 wherein said woven fiberglass material is a leno weave fiberglass fabric.

3. A covering according to claim 1 wherein said first layer includes PVC.

4. A covering according to claim 1 wherein said second layer includes PVC.

5. A covering according to claim 4 wherein said first layer includes PVC.

6. A covering according to claim 5 wherein said woven fiberglass material is a leno weave fiberglass fabric.

7. A covering according to claim 1 wherein said woven fiberglass material is in contact with and lies between said first and second layers.

8. A covering according to claim 1 wherein said covering comprises a floor covering.

9. A covering according to claim 1 wherein said precoat layer is a VAE layer.

10. A covering according to claim 1 wherein the fiberglass fabric includes warp and weft yarns, said warp yarns being passed from side to side and twisted with said weft yarns extending between the twisted warp yarns.

11. A covering according to claim 10 wherein said first layer includes PVC.

12. A covering according to claim 10 wherein said second layer includes PVC.

13. A covering according to claim 10 wherein said first layer includes PVC.

14. A covering according to claim 10 wherein said covering comprises a floor covering.

15. A method of forming a wall or floor covering comprising the steps of:
(a) tufting yarn through a primary backing to form a surface with exposed tufts and an undersurface of the primary backing opposite the exposed surface;
(b) applying a precoat of VAE to the undersurface;
(c) applying a first layer of one of a latex, resinous, PVC or adhesive material to the VAE precoat;
(d) applying a second layer of one of a latex, resinous, PVC or adhesive material to the woven material;
(e) applying a woven fiberglass in contact with one of said VAE precoat, said first layer and said second layer.

16. A method according to claim 15 wherein steps (b) and (c) include applying first and second layers, respectively, of PVC.

17. A method according to claim 15 wherein step (e) includes applying a leno weave fiberglass.

18. A method according to claim 15 including, immediately following step (b) and before step (c), curing the VAE precoat.

19. A method according to claim 15 including following step (e) and before step (d), embedding the fiberglass into the first layer.

20. A method according to claim 15 wherein steps (b) and (c) include applying first and second layers, respectively, of PVC, including, immediately following step (b) and before step (e), curing the VAE precoat and following step (e) and before step (d), embedding the fiberglass into the first layer.
